(19) United States
(12) Patent Application Publication
(10) Pub. No.: US 2026/0021616 A1
(43) Pub. Date: Jan. 22, 2026

(54) MOLD FOR MOLDING RESIN LAYER INTEGRALLY WITH CORE METAL OF STEERING DEVICE OF MOVING OBJECT, AND METHOD OF MANUFACTURING STEERING DEVICE OF MOVING OBJECT WHERE RESIN LAYER IS MOLDED INTEGRALLY WITH CORE METAL

(71) Applicant: TOYODA GOSEI CO., LTD., Kiyosu-shi (JP)

(72) Inventors: Yuki KAMIYA, Kiyosu-shi (JP); Shinsuke FUKUSHIGE, Kiyosu-shi (JP); Naoyuki KUMAGAI, Kiyosu-shi (JP); Yuichi KINO, Kiyosu-shi (JP)

(21) Appl. No.: 19/237,398

(22) Filed: Jun. 13, 2025

(30) Foreign Application Priority Data
Jul. 19, 2024 (JP) 2024-115407

(51) Int. Cl. B29C 45/27; B29C 45/14; B29C 45/34; B29K 705/00; B29L 31/30

(52) U.S. Cl. CPC B29C 45/2708; B29C 45/14336; B29C 45/34; B29K 2705/00; B29L 2031/3047

(57) ABSTRACT

A mold for molding a resin layer integrally with a core metal of a steering device of a moving object is provided. The core metal includes a hub core metal part connecting to an axis of steering rotation, a spoke core metal part connecting to the hub core metal part, and a rim core metal part connecting to the spoke core metal part. The mold comprises: a spoke molding part for molding the resin layer integrally with the spoke core metal part; a rim molding part for molding the resin layer integrally with the rim core metal part; and a gate for flowing a resin material into the mold. Of the spoke molding part and the rim molding part, the gate is provided at the spoke molding part.

### CROSS REFERENCE TO RELATED APPLICATIONS

The present application claims priority from Japanese patent application P2024-115407 filed on Jul. 19, 2024, the disclosure of which is hereby incorporated in its entirety by reference into the present application.

### BACKGROUND

### Field

The present disclosure relates to a mold for molding a resin layer integrally with a core metal of a steering device of a moving object, and a method of manufacturing a steering device of a moving object where a resin layer is molded integrally with a core metal.

### Related Art

Japanese Patent Application Publication No. 9-207159 discloses a mold for molding a resin layer integrally with a core metal of a steering wheel. In such a mold, a gate for injection of a resin material is provided at an outer peripheral surface of a ring part of the steering wheel to be gripped by a passenger. When molding of the resin is completed, a gate residue is generated at the position of the gate. The gate residue is resin having been cured in conformity with the shape of the gate.

As the ring part is to be gripped by a passenger, the gate residue attached to the ring part is required to be excised along the shape of the ring part. An excision mark of the gate residue might worsen a feel of the steering device sensed by a passenger gripping the steering device. Such a problem is common to a steering device having a grip of an arbitrary shape other than the ring shape.

### SUMMARY

The present disclosure is feasible as the following aspects.

According to one aspect of the present disclosure, a mold for molding a resin layer integrally with a core metal of a steering device of a moving object is provided. The core metal includes a hub core metal part connecting to an axis of steering rotation of the moving object, a spoke core metal part connecting to the hub core metal part and being a skeleton of a spoke of the steering device, and a rim core metal part connecting to the spoke core metal part and being a skeleton of a rim to be gripped by a passenger of the moving object. The mold comprises: a spoke molding part for molding the resin layer integrally with the spoke core metal part; a rim molding part for molding the resin layer integrally with the rim core metal part; and a gate for flowing a resin material into the mold. Of the spoke molding part and the rim molding part, the gate is provided at the spoke molding part.

### BRIEF DESCRIPTION OF THE DRAWINGS

FIG. 1 is a perspective view showing a schematic configuration of a mold according to an embodiment of the present disclosure;

FIG. 2 is a perspective view of a molded article with which a resin layer is integrally molded;

FIG. 3 is a sectional view along a line III-III in FIG. 1;

FIG. 4 is a process chart of a method of manufacturing a steering device of a vehicle where the resin layer is molded integrally with a core metal; and

FIG. 5 is a front view of a molded article manufactured using a mold of a second embodiment.

### DETAILED DESCRIPTION

### A. First Embodiment

### <Overall Configuration>

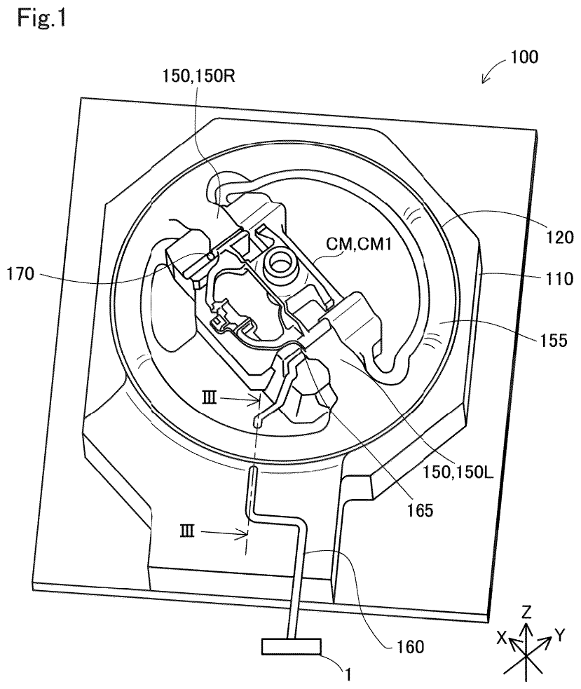

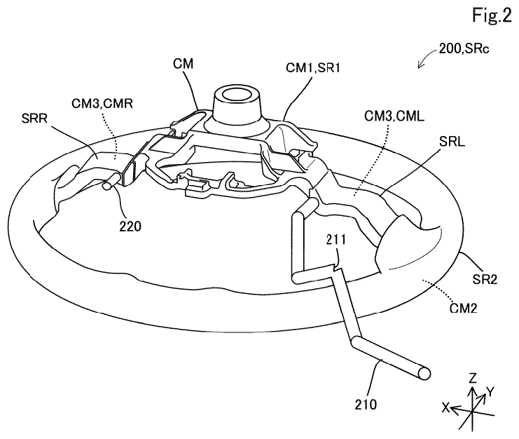

FIG. 1 is a perspective view showing a schematic configuration of a mold 100 according to an embodiment of the present disclosure. FIG. 2 is a perspective view of a molded article 200 with which a resin layer is integrally molded. FIG. 1 shows the mold 100 in a state where a core metal CM is placed therein. The mold 100 is used for molding the resin layer integrally with the core metal CM of a steering device SR of a vehicle. The steering device SR of the present embodiment includes a hub SR1 connecting to an axis of steering rotation of the vehicle, an annular rim SR2 to be gripped by a passenger of the vehicle, and spokes SRL and SRR in a pair connecting the hub SR1 and the rim SR2 to each other. The steering device SR of the present embodiment is a circular wheel. The core metal CM is a skeleton of the steering device SR and is made of metal. The core metal CM includes a hub core metal part CM1 that is a skeleton of the hub SR1, a rim core metal part CM2 that is a skeleton of the rim SR2, and a spoke core metal part CM3 that is a skeleton of the spokes SRL and SRR. The spoke core metal part CM3 connects the hub core metal part CM1. The rim core metal part CM2 connects the spoke core metal part CM3. In the present embodiment, the spoke core metal part CM3 includes a first core metal part CML and a second core metal part CMR provided at positions symmetrical to each other with respect to the hub core metal part CM1 when the core metal CM is viewed from the front. In other words, at a position of rotation where the steering device SR is mounted on the vehicle and the vehicle is caused to run straightforward, the first core metal part CML and the second core metal part CMR are at positions symmetrical to each other with respect to a plane including the axis of steering rotation and an axis parallel to a frontward-backward direction of the vehicle. Likewise, the spokes SRL and SRR with the first core metal part CML and the second core metal part CMR respectively provided with the resin layer are at positions symmetrical to each other.

An X axis, a Y axis, and a Z axis shown in the drawings are axes indicating directions intersecting each other. In the following, directions toward arrowheads will be used as +directions, and directions opposite to the + directions will be used as − directions.

### <Configuration of Mold 100>

As shown in FIG. 1, the mold 100 includes a lower mold 110 and an upper mold 120. The core metal CM is placed in the lower mold 110 and thereafter the upper mold 120 is overlaid thereon. With the lower mold 110 and the upper mold 120 overlaid on each other, a resin material is introduced into the mold 100 to mold the resin layer integrally with the core metal CM. In the present embodiment, the resin layer is absent at the hub core metal part CM1. Thus, with the core metal CM placed in the mold 100, the hub core metal part CM1 is exposed to the outside. The mold 100 includes a spoke molding part 150, a rim molding part 155, a runner 160, a gate 165, and a vent 170.

The spoke molding part 150 is a flow passage for molding the resin layer integrally with the spoke core metal part CM3. The spoke core metal part CM3 is placed inside the spoke molding part 150. In the present embodiment, the spoke molding part 150 includes a first molding part 150L for molding the resin layer integrally with the first core metal part CML and a second molding part 150R for molding the resin layer integrally with the second core metal part CMR. With the core metal CM placed in the mold 100, the first molding part 150L and the second molding part 150R are at positions symmetrical to each other with respect to the hub core metal part CM1.

The rim molding part 155 is a flow passage for molding the resin layer integrally with the rim core metal part CM2. The rim core metal part CM2 is placed inside the rim molding part 155. The rim molding part 155 has an annular appearance shape. The rim molding part 155 connects to the first molding part 150L and the second molding part 150R.

The runner 160 is a flow passage for feeding the resin material from an injection unit 1. The resin material heated by the injection unit 1 is fed via the runner 160. The runner 160 has a tubular shape. The runner 160 climbs over the rim molding part 155 to connect to the gate 165 provided at the first molding part 150L. The runner 160 will be described later in detail.

The gate 165 is a feed opening flowing the resin material into the mold 100. The gate 165 connects to the runner 160. Of the spoke molding part 150 and the rim molding part 155, the gate 165 is provided at the spoke molding part 150. In the present embodiment, the gate 165 is provided at the first molding part 150L. More specifically, the gate 165 is provided at an end portion of the first molding part 150L closer to the rim core metal part CM2.

The vent 170 is a hole for discharging air from the interior of the mold 100. Of the spoke molding part 150 and the rim molding part 155, the vent 170 is provided at the spoke molding part 150. In the present embodiment, the vent 170 is provided at the second molding part 150R. More specifically, the vent 170 is provided at an end portion of the second molding part 150R closer to the rim core metal part CM2. It may also be said that the gate 165 and the vent 170 are provided at positions symmetrical to each other with respect to the hub core metal part CM1. The resin material is fed from the gate 165, and passes through the first molding part 150L, the rim molding part 155, and the second molding part 150R in this order while pushing out the air in the mold 100. The resin material passes through inside the rim molding part 155 while branching into the +Y direction and the-Y direction at a connection between the first molding part 150L and the rim molding part 155. The air pushed out at this time is discharged from the mold 100 via the vent 170.

### <Excision of Gate Residue 210 and Vent Residue 220>

The molded article 200 in FIG. 2 results from curing of the resin having been flowed into the mold 100 in FIG. 1. The core metal CM is provided with the resin layer molded thereon, and also with a gate residue 210 and a vent residue 220 generated thereon. The gate residue 210 is a cured substance of the resin material present in the runner 160 and at a site of the gate 165. The vent residue 220 is a cured substance of the resin material having been discharged from the vent 170 together with the air. The gate residue 210 and the vent residue 220 each have a tubular appearance shape. The gate residue 210 and the vent residue 220 are excised from their roots with a nipper, for example.

### <Detailed Configuration of Runner 160>

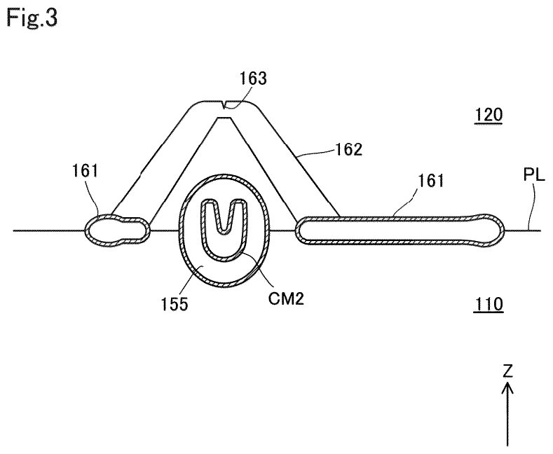

FIG. 3 is a sectional view along a line III-III in FIG. 1. As shown in FIG. 3, the runner 160 includes a feeding part 161 and a traversing part 162. The feeding part 161 is a flow passage provided along a parting line PL as a joint between the upper mold 120 and the lower mold 110. The traversing part 162 is a flow passage connecting to the feeding part 161 and traversing over the rim molding part 155 (+Z direction). The traversing part 162 is a flow passage provided in the upper mold 120 and having a V-shape in a III-III section. The traversing part 162 is provided with a projection 163 projecting toward the rim molding part 155. As shown in FIG. 2, with the presence of the projection 163, the gate residue 210 is provided with an incision 211 conforming to the shape of the projection 163.

According to the mold 100 of the first embodiment described above, of the spoke molding part 150 and the rim molding part 155, the gate 165 is provided at the spoke molding part 150. Thus, an excision mark of the gate residue 210 occurs at the spoke SRL. The spoke SRL is less likely to be touched by a passenger than the rim SR2. This makes it possible to reduce worsening of a feel of the steering device SR compared to a case where an excision mark of the gate residue 210 occurs at the rim SR2. If a decorative component such as a bezel is arranged at the spoke SRL, the decorative component may be used for covering the excision mark. Thus, it is possible to suppress reduction in design features and also to eliminate a step for finishing the excision mark smoothly.

According to the mold 100 of the first embodiment, of the spoke molding part 150 and the rim molding part 155, the vent 170 is provided at the spoke molding part 150. Thus, an excision mark of the vent residue 220 occurs at the spoke SRR. The spoke SRR is less likely to be touched by a passenger than the rim SR2. This makes it possible to reduce worsening of a feel of the steering device SR compared to a case where an excision mark of the vent residue 220 occurs at the rim SR2. If a decorative component such as a bezel is arranged at the spoke SRR, the decorative component may be used for covering the excision mark. Thus, it is possible to suppress reduction in design features and also to eliminate a step for finishing the excision mark smoothly.

According to the mold 100 of the first embodiment, the spoke molding part 150 includes the first molding part 150L and the second molding part 150R present at positions symmetrical to each other, the gate 165 is provided at the first molding part 150L, and the vent 170 is provided at the second molding part 150R. This reduces imbalance of the resin material to be flowed into the mold 100 compared to a case where the gate 165 and the vent 170 are provided at asymmetrical sites. This makes it possible to reduce unevenness of the quality of the resin layer between sites.

According to the mold 100 of the first embodiment, the runner 160 is provided in the upper mold 120 and includes the traversing part 162 passing over the rim molding part 155. This allows a mold release agent contained in the resin material to be less likely to retain in the traversing part 162 than in a case where the traversing part 162 is provided in the lower mold 110 and passes under the rim molding part 155.

According to the mold 100 of the first embodiment, the projection 163 for forming the incision 211 at the gate residue 210 is provided in the traversing part 162. This allows the gate residue 210 to be cut using the incision 211 during mold opening of the mold 100. More specifically, as the traversing part 162 is present in the upper mold 120 as shown in FIG. 3, the gate residue 210 in the traversing part 162 is required to be cut in separating the lower mold 110 and the upper mold 120 from each other during mold opening. Forming the incision 211 at the gate residue 210 like in the present embodiment allows the gate residue 210 to be cut easily.

### B. Method of Manufacturing Steering Device SR of Vehicle Where Resin Layer is Molded Integrally With Core Metal CM

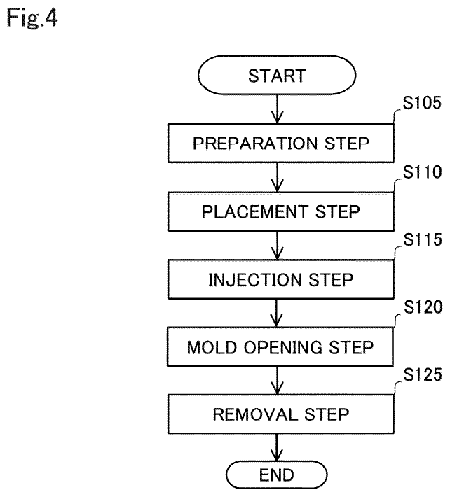

FIG. 4 is a process chart of a method of manufacturing the steering device SR of a vehicle where the resin layer is molded integrally with the core metal CM (this method will be called a method of manufacturing the steering device SR below). The method of manufacturing the steering device SR is implemented as one of steps of manufacturing the vehicle.

As shown in FIG. 4, in a preparation step (step S105), the core metal CM, the resin material, and the mold 100 are prepared. The core metal CM of the present embodiment is an annular wheel including the above-described hub core metal part CM1, rim core metal part CM2, and the spoke core metal part CM3 shown in FIGS. 1 and 2. The resin material contains a chief material, a curing agent, and the mold release agent. The chief material is polyol, for example. The curing agent is isocyanate, for example. Arbitrary materials available for injection molding of resin may be used as the chief material, the curing agent, and the mold release agent. The resin material may contain an arbitrary colorant. The mold 100 of the present embodiment includes the spoke molding part 150, the rim molding part 155, and the gate 165 shown in FIG. 1. Of the spoke molding part 150 and the rim molding part 155, the gate 165 is provided at the spoke molding part 150.

As shown in FIG. 4, in a placement step (step S110), the core metal CM is placed into the mold 100. More specifically, the core metal CM is placed in the lower mold 110 and the upper mold 120 and the lower mold 110 are overlaid on each other.

In an injection step (step S115), the resin material is injected into the mold 100. The resin material melted by heating by the injection unit 1 shown in FIG. 1 is injected into the mold 100 via the runner 160 and the gate 165. The resin material passes through the first molding part 150L, the rim molding part 155, and the second molding part 150R in this order. When the interiors of the spoke molding part 150 and the rim molding part 155 are filled with the resin material, a surplus of the resin material is discharged to the outside of the mold 100 via the vent 170.

As shown in FIG. 4, in a mold opening step (step S120), the upper mold 120 and the lower mold 110 of the mold 100 are opened and the molded article 200 is taken out. While the molded article 200 shown in FIG. 2 is in a state before cutting of the gate residue 210, the gate residue 210 is actually cut at the incision 211 as a boundary.

As shown in FIG. 4, in a removal step (step S125), the gate residue 210 is removed from the molded article 200. More specifically, the tubular gate residue 210 shown in FIG. 2 is excised from its root at a connection with the spoke SRL. In doing this, the gate residue 210 is excised in such a manner as to minimize an excision mark. If the vent residue 220 is present, the vent residue 220 may be excised in this step in the same way as the gate residue 210.

The steering device SR manufactured by a series of the steps described above is next mounted with a decorative component such as an illumination unit or a bezel.

### C. Second Embodiment

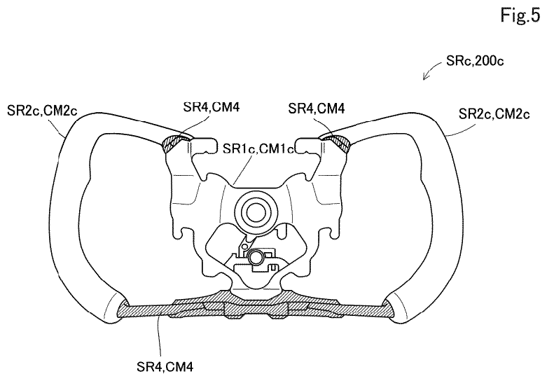

FIG. 5 is a front view of a molded article 200c manufactured using a mold of a second embodiment. While the molded article 200 manufactured using the mold 100 of the first embodiment is the annular steering device SR, a steering device SRc of the second embodiment is a so-called deformed wheel having a butterfly-type appearance shape. Regarding a configuration not described below, such a configuration is similar to that of the first embodiment so description thereof will be omitted. As shown in FIG. 5, the steering device SRc of the second embodiment includes a hub SR1c, rims SR2c, and a mount part SR4.

The hub SR1c connects to an axis of steering rotation of a vehicle and is located at a center of the steering device SRc. In the present embodiment, as a resin layer is not molded integrally with the hub SR1c, a hub core metal part CM1c that is a skeleton thereof is exposed to the outside.

The rims SR2c are to be gripped by a passenger to drive the vehicle. The rims SR2c are provided one on the right and one on the left in FIG. 5. The rims SR2c each have an L appearance shape. The rims SR2c are manufactured by molding a resin layer integrally with rim core metal parts CM2c that are skeletons thereof. Each of the rims SR2c in a pair connects to the hub SR1c at an upper portion thereof in FIG. 5.

The mount part SR4 is mounted with a decorative component. The “decorative component” is a component such as a pad, a garnish, a cover, or an illumination unit to be mounted for improving the design features or functionality of the steering device SRc. In FIG. 5, the mount part SR4 is hatched. The mount part SR4 is located in an area where the hub SR1c and each of the rims SR2c connect to each other and in an area where the rims SR2c in a pair connect to each other. The mount part SR4 is manufactured by molding the resin layer integrally with a mount core metal part CM4 that is a skeleton thereof. The mount part SR4 is provided with an engagement structure such as a projection or a hole for mounting of the decorative component.

A mold used for manufacturing the steering device SRc described above includes a rim molding part for molding the resin layer integrally with the rim core metal part CM2c, and a mount molding part for molding the resin layer integrally with the mount core metal part CM4. Of the rim molding part and the mount molding part, a gate for flowing a resin material into the mold is provided at the mount molding part. Thus, a gate residue is generated in a state of being attached to the mount part SR4, and an excision mark of the gate residue occurs at the mount part SR4.

Of the rim molding part and the mount molding part, a vent for discharging air from the above mold is provided at the mount molding part. Thus, like the gate residue, a vent residue is generated in a state of being attached to the mount part SR4, and an excision mark of the vent residue occurs at the mount part SR4.

According to the mold of the second embodiment described above, of the mount molding part and the rim molding part, the gate is provided at the mount molding part. Thus, an excision mark of the gate residue occurs at the mount part SR4. As the mount part SR4 is mounted with the decorative component, the decorative component may be used for covering the excision mark. Thus, it is possible to reduce worsening of a feel of the steering device SRc and suppress reduction in design features due to the excision mark of the gate residue.

According to the mold of the second embodiment, of the mount molding part and the rim molding part, the vent is provided at the mount molding part. Thus, an excision mark of the vent residue occurs at the mount part SR4. As the mount part SR4 is mounted with the decorative component, the decorative component may be used for covering the excision mark. Thus, it is possible to reduce worsening of a feel of the steering device SRc and suppress reduction in design features due to the excision mark of the vent residue.

### D. Other Embodiments

(D1) In the above-descried first embodiment, the steering device SR has an annular appearance shape. However, the present disclosure is not limited to this. The steering device SR may be a deformed wheel having a D-shape or a butterfly shape, for example. In the above-described second embodiment, the steering device SRc is a deformed wheel having a butterfly shape. However, the present disclosure is not limited to this. The steering device SRc may have an annular appearance shape. Specifically, each of the steering devices SR and SRc of the present disclosure may be a wheel of an arbitrary shape.
(D2) In the above-descried first embodiment, the projection 163 may be realized by providing an arbitrary blade in the traversing part 162.
(D3) In the above-descried second embodiment, the steering device SRc does not include the spokes SRL and SRR. However, the present disclosure is not limited to this. The steering device SRc may include the spokes SRL and SRR.
(D4) In each of the above-descried embodiments, each of the steering devices SR and SRc may be installed on an arbitrary moving object other than a vehicle. Such a moving object is a ship, an airplane, a starship, or a so-called flying automobile, for example. The moving object is not necessarily an object to move but may be an object such as a simulator to realize virtual moving, for example.

The present disclosure is not limited to the embodiments described above and is able to be realized with various configurations without departing from the spirit thereof. For example, technical features in the embodiments are able to be replaced with each other or combined together as appropriate in order to solve part or the whole of the problems described previously or to achieve part or the whole of the effects described previously. When the technical features are not described as essential features in the present specification, they are able to be deleted as appropriate. For example, the present disclosure may be realized as aspects described next.
(1) According to one aspect of the present disclosure, a mold for molding a resin layer integrally with a core metal of a steering device of a moving object is provided. The core metal includes a hub core metal part connecting to an axis of steering rotation of the moving object, a spoke core metal part connecting to the hub core metal part and being a skeleton of a spoke of the steering device, and a rim core metal part connecting to the spoke core metal part and being a skeleton of a rim of the steering device to be gripped by a passenger of the moving object. The mold comprises: a spoke molding part for molding the resin layer integrally with the spoke core metal part; a rim molding part for molding the resin layer integrally with the rim core metal part; and a gate for flowing a resin material into the mold. Of the spoke molding part and the rim molding part, the gate is provided at the spoke molding part.

According to the mold of this aspect, of the spoke molding part and the rim molding part, the gate is provided at the spoke molding part. Thus, an excision mark of a gate residue occurs at the spoke of the steering device. The spoke is less likely to be touched by the passenger than the rim. This makes it possible to reduce worsening of a feel of the steering device due to the excision mark of the gate residue.
(2) The mold according to the above-described aspect may further comprise a vent for discharging air from the mold. Of the spoke molding part and the rim molding part, the vent is provided at the spoke molding part.

According to the mold of this aspect, of the spoke molding part and the rim molding part, the vent is provided at the spoke molding part. Thus, an excision mark of a vent residue occurs at the spoke of the steering device. The spoke is less likely to be touched by the passenger than the rim. This makes it possible to reduce worsening of a feel of the steering device due to the excision mark of the vent residue.
(3) In the mold according to the above-described aspect, the spoke core metal part may include a first core metal part and a second core metal part provided at positions symmetrical to each other with respect to the hub core metal part when the core metal is viewed from the front, the spoke molding part may include a first molding part for molding the resin layer integrally with the first core metal part and a second molding part for molding the resin layer integrally with the second core metal part, the gate may be provided at the first molding part, and the vent may be provided at the second molding part.

According to the mold of this aspect, the gate is provided at the first molding part and the vent is provided at the second molding part, so that the gate and the vent are provided at sites symmetrical to each other. This reduces imbalance of the resin material to be fed into the mold to allow reduction in unevenness of the quality of the resin layer between sites compared to a case where the gate and the vent are located at asymmetrical sites.
(4) The mold according to the above-described aspect may further comprise a runner as a flow passage connecting to the gate and causing the resin material to pass therethrough, and the runner may include a traversing part provided in an upper mold of the mold and passing over the rim molding part.

According to the mold of this aspect, the runner includes the traversing part provided in the upper mold and passing over the rim molding part. This allows a mold release agent contained in the resin material to be less likely to retain in the traversing part than in a case where the traversing part is provided in a lower mold and passes under the rim molding part.
(5) In the mold according to the above-described aspect, a projection for forming an incision at a gate residue may be provided in the traversing part. The gate residue results from curing of resin in the traversing part.

According to the mold of this aspect, the projection is provided in the traversing part. Thus, during mold opening of the mold, it is possible to cut the gate residue in the traversing part easily using the incision formed by the projection.
(6) According to another aspect of the present disclosure, a mold for molding a resin layer integrally with a core metal of a steering device of a moving object is provided. The core metal includes a mount core metal part that is a skeleton of a mount part to be mounted with a decorative component in the steering device, and a rim core metal part connecting to the mount core metal part and being a skeleton of a rim to be gripped by a passenger of the moving object. The mold comprises: a mount molding part for molding the resin layer integrally with the mount core metal part; a rim molding part for molding the resin layer integrally with the rim core metal part; and a gate for flowing a resin material into the mold. Of the mount molding part and the rim molding part, the gate is provided at the mount molding part.

According to the mold of this aspect, of the mount molding part and the rim molding part, the gate is provided at the mount molding part. Thus, an excision mark of a gate residue occurs at the mount part of the steering device. The mount part is covered by being mounted with the decorative component. Thus, the mount part is less likely to be touched by the passenger than the rim. This makes it possible to reduce worsening of a feel of the steering device due to the excision mark of the gate residue. Furthermore, as the mount part is covered with the decorative component, it is possible to suppress reduction in design features due to the excision mark of the gate residue.
(7) The mold according to the above-described aspect may further comprise a vent for discharging air from the mold. Of the mount molding part and the rim molding part, the vent is provided at the mount molding part.

According to the mold of this aspect, of the mount molding part and the rim molding part, the vent is provided at the mount molding part. Thus, an excision mark of a vent residue occurs at the mount part of the steering device. The mount part is covered by being mounted with the decorative component. Thus, the mount part is less likely to be touched by the passenger than the rim. This makes it possible to reduce worsening of a feel of the steering device due to the excision mark of the vent residue. Furthermore, as the mount part is covered with the decorative component, it is possible to suppress reduction in design features due to the excision mark of the vent residue.

The present disclosure is also feasible as various aspects. For example, the present disclosure may be realized as aspects such as a method of manufacturing a steering device using a mold, a steering device manufactured using a mold, and others.

What is claimed is:

1. A mold for molding a resin layer integrally with a core metal of a steering device of a moving object, the core metal including a hub core metal part connecting to an axis of steering rotation of the moving object, a spoke core metal part connecting to the hub core metal part and being a skeleton of a spoke of the steering device, and a rim core metal part connecting to the spoke core metal part and being a skeleton of a rim of the steering device to be gripped by a passenger of the moving object,
the mold comprising:
a spoke molding part for molding the resin layer integrally with the spoke core metal part;
a rim molding part for molding the resin layer integrally with the rim core metal part; and
a gate for flowing a resin material into the mold, of the spoke molding part and the rim molding part, the gate being provided at the spoke molding part.

2. The mold according to claim 1, further comprising:
a vent for discharging air from the mold, of the spoke molding part and the rim molding part, the vent being provided at the spoke molding part.

3. The mold according to claim 2, wherein
the spoke core metal part includes a first core metal part and a second core metal part provided at positions symmetrical to each other with respect to the hub core metal part when the core metal is viewed from the front,
the spoke molding part includes a first molding part for molding the resin layer integrally with the first core metal part and a second molding part for molding the resin layer integrally with the second core metal part,
the gate is provided at the first molding part, and
the vent is provided at the second molding part.

4. The mold according to claim 1, further comprising:
a runner as a flow passage connecting to the gate and causing the resin material to pass therethrough, wherein
the runner includes a traversing part provided in an upper mold of the mold and passing over the rim molding part.

5. The mold according to claim 4, wherein
a projection for forming an incision at a gate residue is provided in the traversing part, the gate residue resulting from curing of resin in the traversing part.

6. A mold for molding a resin layer integrally with a core metal of a steering device of a moving object,
the core metal including a mount core metal part being a skeleton of a mount part to be mounted with a decorative component in the steering device, and a rim core metal part connecting to the mount core metal part and being a skeleton of a rim to be gripped by a passenger of the moving object,
the mold comprising:
a mount molding part for molding the resin layer integrally with the mount core metal part;
a rim molding part for molding the resin layer integrally with the rim core metal part; and
a gate for flowing a resin material into the mold, of the mount molding part and the rim molding part, the gate being provided at the mount molding part.

7. The mold according to claim 6, further comprising:
a vent for discharging air from the mold, of the mount molding part and the rim molding part, the vent being provided at the mount molding part.

8. A method of manufacturing a steering device of a moving object where a resin layer is molded integrally with a core metal, comprising:
preparing a core metal, a resin material, and a mold including a spoke molding part and a rim molding part, the mold being provided with a gate, of the spoke molding part and the rim molding part, the gate being provided at the spoke molding part;
placing the core metal into the mold;
injecting the resin material into the mold;
opening the mold and taking out a molded article;
removing a gate residue from the molded article.
